(19) United States
(12) Patent Application Publication
(10) Pub. No.: US 2017/0009435 A1
(43) Pub. Date: Jan. 12, 2017

(54) SHOWER HEAD WATER REGULATOR

(71) Applicant: Stephen S. Burns, Maineville, OH (US)

(72) Inventor: Stephen S. Burns, Maineville, OH (US)

(21) Appl. No.: 15/203,918

(22) Filed: Jul. 7, 2016

Related U.S. Application Data
(60) Provisional application No. 62/189,245, filed on Jul. 7, 2015.

(51) Int. Cl. E03C 1/05; B05B 15/06; B05B 12/12; B05B 1/18; B05B 1/30

(52) U.S. Cl. CPC E03C 1/057; B05B 1/18; B05B 1/3013; B05B 12/124; B05B 15/065; F16K 31/0655

(57) ABSTRACT

According to an embodiment, a showerhead for automatically regulating water flow is provided. The showerhead comprises a range sensor, a solenoid, and a microprocessor. The range sensor is configured to detect the presence or absence of a person near the showerhead and to generate a range signal. The microprocessor is configured to receive the range signal and to determine a person's typical distance from the showerhead when rinsing. Further, based on the range signal, the microprocessor is configured to send an open signal to the solenoid valve when the person is within the typical distance and to send a close signal to the solenoid valve when the person is outside of the typical distance. The solenoid valve is configured to be opened and closed by the respective open or close signals to respectively turn on or off the flow of water based on the person's position relative to the showerhead.

### CROSS REFERENCE TO RELATED APPLICATION

Pursuant to 37 C.F.R. §1.78(a)(4), this application claims the benefit of and priority to prior filed co-pending Provisional Application Ser. No. 62/189,245 filed Jul. 7, 2015, which is expressly incorporated herein by reference.

### FIELD OF THE INVENTION

This invention relates generally to a showerhead for regulating water flow, and more particularly to a showerhead that is automated and provides a water-saving functionality.

### BACKGROUND OF THE INVENTION

Showering is an important part of the regular routine of many individuals throughout the world. In recent years, significant efforts have been expended to reduce the amount of water used when showering, for both cost-saving reasons and in the interest of reducing environmental impact. For example, many parts of the world suffer from drought conditions resulting in shortages of drinking water for their populations.

Generally speaking, a large portion of potable water is used for showers. For example, in the United States, water consumption for showering is estimated to be as high as 9,000 gallons of water per person, per year. However, as much as half of this water is often wasted and flows down the shower drain without ever being used. In this regard, this waste of water occurs, for example, when the individual using the shower is temporarily not standing beneath the showerhead while the water is running. This wasteful misuse of water results in the unnecessary depletion of the water supply, and leads to unnecessarily excessive water bills that are disproportionate to the amount of water actually used.

In an effort to reduce the amount of wasted water from showering, some efforts have turned to the use of presence detection technology for shower related flow control. For example, U.S. Pat. No. 5,829,072, which is hereby incorporated by reference in its entirety, generally describes the use of a motion sensor near the faucet handles of a shower to automatically start and stop water flow based on the presence of a person in the shower.

U.S. Pat. No. 4,998,673 (the '673 patent), which is hereby incorporated by reference in its entirety, describes a system for controlling the flow of water from a showerhead by placing a sensor directly within the showerhead. These early sensor schemes, particularly the scheme disclosed in the '673 patent, suffer from a limitation, namely, that because the sensors are particularly sensitive to the distance between the showering person and the showerhead, the detection scheme performs poorly for people not of the optimal height. This limitation of the '673 patent has been addressed by some systems that provide more elaborate and more sophisticated sensing schemes to accommodate variations in height. These, however, generally rely on significantly more expensive hardware.

Such conventional systems suffer from additional drawbacks, such as requiring complicated installation. In addition, existing solutions may fail to maintain a constant temperature between turning the water flow off and on.

### SUMMARY OF THE INVENTION

A need exists for an improved showerhead which is self-contained and designed to be a plug-and-play replacement for almost any showerhead in the world. The disclosed and other embodiments according to this invention provide a solution to the above-referenced problems by providing a showerhead that automatically regulates water flow and is easy to install, use, and maintain.

According to an embodiment, a showerhead for automatically regulating water flow is provided. The showerhead comprises a range sensor, a solenoid, and a microprocessor. The range sensor is configured to detect the presence or absence of a person near the showerhead and to generate a range signal. The microprocessor is configured to receive the range signal and to determine a person's typical distance from the showerhead when rinsing. Further, based on the range signal, the microprocessor is configured to send an open signal to the solenoid valve when the person is within the typical distance and to send a close signal to the solenoid valve when the person is outside of the typical distance. The solenoid valve is configured to be opened and closed by the respective open or close signals to respectively turn on or off the flow of water based on the person's position relative to the showerhead.

According to a further embodiment, a processor based method of controlling a showerhead is provided. In a first stage, the method includes receiving, by the processor, a range signal from a range sensor. In a second stage, the method includes generating, by the processor, a solenoid control signal based on the received range signal, and in a third stage, the method includes providing the solenoid control signal to the solenoid to control the solenoid to open or close, thereby letting water flow or not flow, respectively, depending on the range signal.

Further embodiments, features, and advantages, as well as the structure and operation of the various embodiments, are described in detail below with reference to the accompanying drawings.

### BRIEF DESCRIPTION OF THE DRAWINGS

Embodiments are described with reference to the accompanying drawings. In the drawings, like reference numbers may indicate identical or functionally similar elements.

FIG. 1 is a schematic illustration of a showerhead controller that regulates water flow of a shower, according to an embodiment.

FIG. 2 is a schematic illustration of a conventional showerhead in a typical assembled configuration.

FIG. 3 is an exploded view of a showerhead disassembled from a water supply pipe illustrating a configuration in which the modular showerhead controller may be installed, according to an embodiment.

FIG. 4 is a schematic illustration of the fully assembled system including the showerhead, the modular controller, and the water supply pipe, according to an embodiment.

FIG. 5 is a schematic illustration of the installed showerhead controller in a configuration in which water is allowed to flow, according to an embodiment.

FIG. 6 is a schematic illustration of the installed showerhead controller in a configuration in which water is prevented from flowing, according to an embodiment.

FIG. 7 is a schematic illustration of a cross sectional view of the installed showerhead controller in a configuration in which water is prevented from flowing, according to an embodiment.

FIG. 8 is a schematic illustration of a cross sectional view of the installed showerhead controller in a configuration in which water is allowed to flow, according to an embodiment.

FIG. 9 is flow chart illustrating a processor based method of controlling a showerhead.

FIG. 10 is a block diagram of an example computer system in which embodiments of the disclosed invention, or portions thereof, may be implemented as computer-readable code, which is executed by one or more processors, according to an embodiment.

### DETAILED DESCRIPTION

This disclosure provides systems and methods for automatically regulating water flow in a shower environment to reduce water consumption.

Reference in this specification to “one embodiment,” “an embodiment,” an “example embodiment,” etc., indicate that the embodiment described may include a particular feature, structure, or characteristic, but not every embodiment may necessarily include the particular feature, structure, or characteristic. Moreover, such phrases are not necessarily referring to the same embodiment. Further, when a particular feature, structure, or characteristic may be described in connection with an embodiment, it may be submitted that it may be within the knowledge of one of ordinary skill in the relevant art to affect such feature, structure, or characteristic in connection with other embodiments whether or not explicitly described.

The following detailed description refers to the accompanying drawings that illustrate exemplary embodiments. Other embodiments are possible, and modifications can be made to the embodiments within the spirit and scope of this description. Those of ordinary skill in the relevant art with access to the teachings provided herein will recognize additional modifications, applications, and embodiments within the scope thereof and additional fields in which embodiments would be of significant utility. Therefore, the detailed description is not meant to limit the embodiments described below.

According to an embodiment, a computerized showerhead is provided that detects when a user has stepped back from the showerhead, and activates an integrated solenoid valve to turn off the water flow until the user steps closer again to the showerhead, as described in greater detail below.

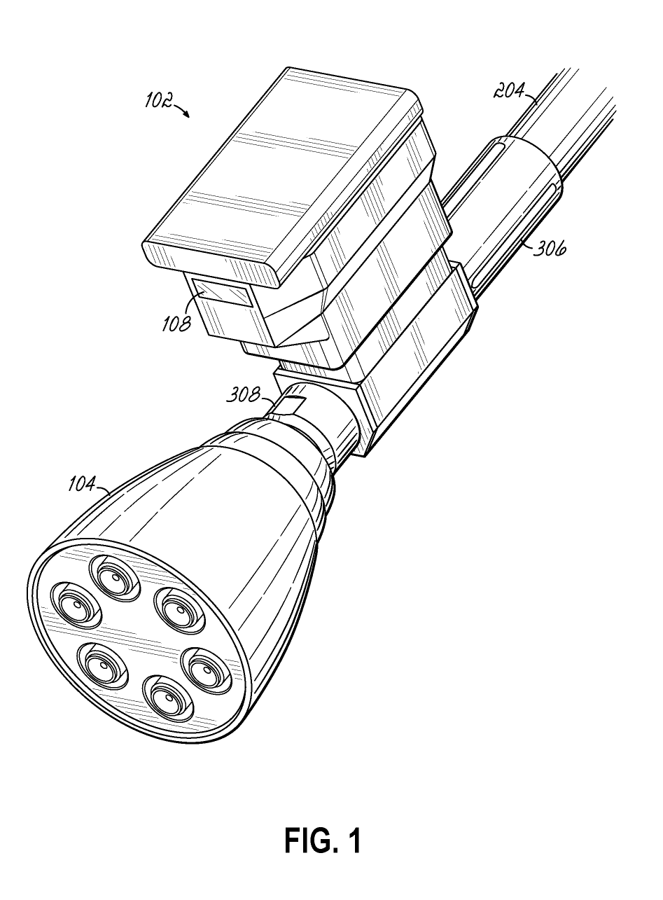

FIG. 1 is a schematic illustration 100 of a showerhead controller that regulates water flow of a shower, according to an embodiment. The embodiment illustrated in FIG. 1 includes a modular controller 102 that is assembled together with a conventional showerhead. The modular controller 102 includes a housing that contains a range sensor 108, a solenoid (not shown in detail), and a microprocessor (also referred to as a “processor”). The modular controller 102 is configured to be compatible with conventional showerheads and is easily installed as described in further detail below with regard to FIGS. 1-4.

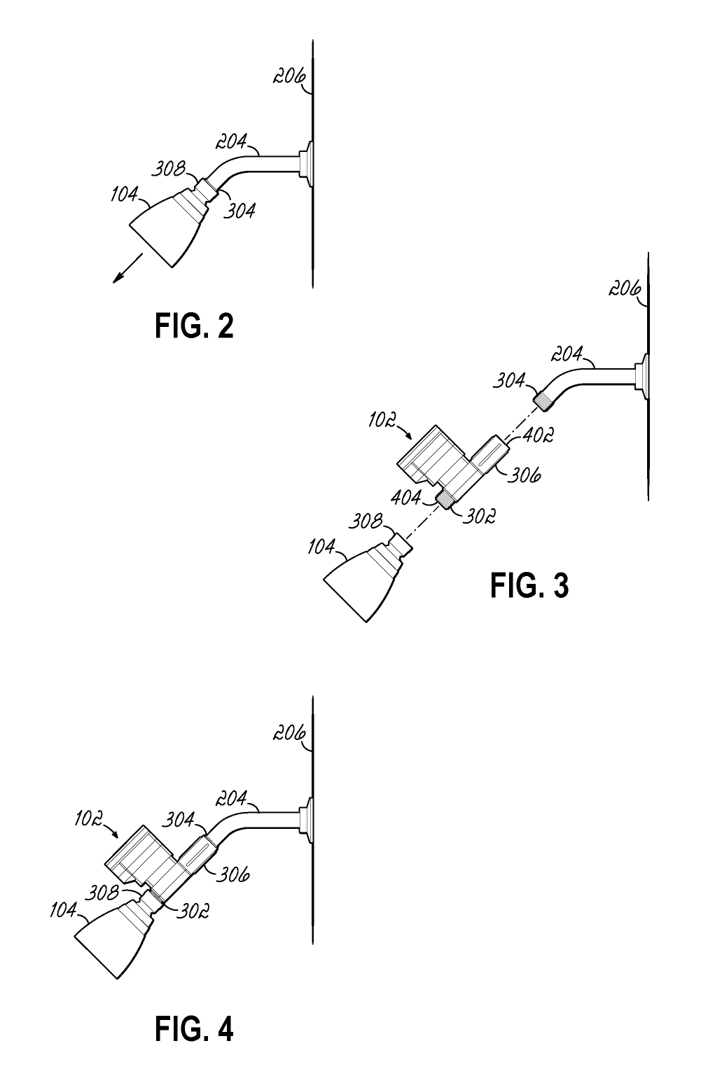

FIG. 2 is a schematic illustration 200 of a conventional showerhead in a typical assembled configuration. This configuration includes a showerhead 104 that is attached to a water supply pipe 204 that is mounted into a wall surface 206. Typically, a showerhead 104 is attached to the water supply pipe 204 through a conventional screw mounting. As such, the showerhead 104 may easily be removed by unscrewing the showerhead 104 from the water supply pipe 204. As such, the modular controller 102 (see FIG. 1) may easily be installed as shown in FIG. 3 and described in greater detail below.

FIG. 3 is an exploded view 300 of the showerhead 104 disassembled from the water supply pipe 204 illustrating a configuration in which the modular controller 102 may be installed, according to an embodiment. The modular controller 102 has a threaded portion that is similar to a threaded portion 304 of the water supply pipe 204. As such, the showerhead 104 may easily be mounted to the modular controller 102 by screwing the showerhead 104 onto the threaded portion 302 of the modular controller. The modular controller 102 has a threaded portion 306 that is similar to a corresponding threaded portion 308 of the showerhead 104. As such, the modular controller 102 may be mounted to the water supply pipe 204 by screwing the modular controller 102 onto the water supply pipe. Once installed the showerhead controller forms the configuration illustrated in FIG. 4, as described in greater detail below.

FIG. 4 is a schematic illustration 400 of the fully assembled system including the showerhead 104, the modular controller 102, and the water supply pipe 204, according to an embodiment. In the configuration of FIG. 4, water enters a first end 402 of the modular controller 102 and flows out from a second end 404 of the modular controller into the showerhead 104. As described in greater detail below, the modular controller 102 controls the flow of water from the water supply pipe 204 to the showerhead 104 based on a signal generated by the range sensor 108.

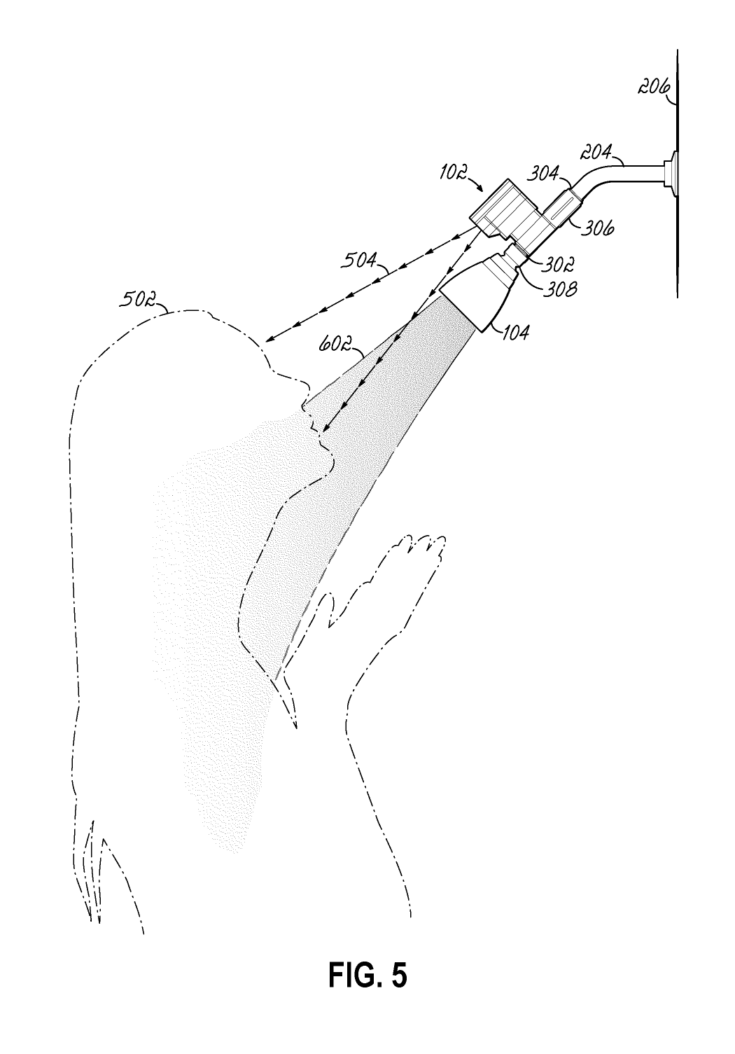

FIG. 5 is a schematic illustration 500 of the installed showerhead controller in a configuration in which water is allowed to flow, according to an embodiment. In this example, a person 502 is standing within a predetermined distance range from the showerhead controller. According to an embodiment, the predetermined distance range may have a value from 5-40 inches, from 10-30 inches, from 15-25 inches, etc. The presence of the person 502 is detected by the range sensor 108. According to an embodiment, the range sensor 108 may be an infrared sensor. In a further embodiment, the range sensor 108 may be an ultrasonic sensor. The range sensor detects the presence of the person 502 by emitting and receiving infrared radiation 504, in the case of the infrared sensor, and detects the presence of the person 502 by emitting and receiving ultrasonic waves 504, in the case of the ultrasonic sensor. When the person 502 steps away from the showerhead 104 the controller 102 stops the flow of water, as described in further detail below.

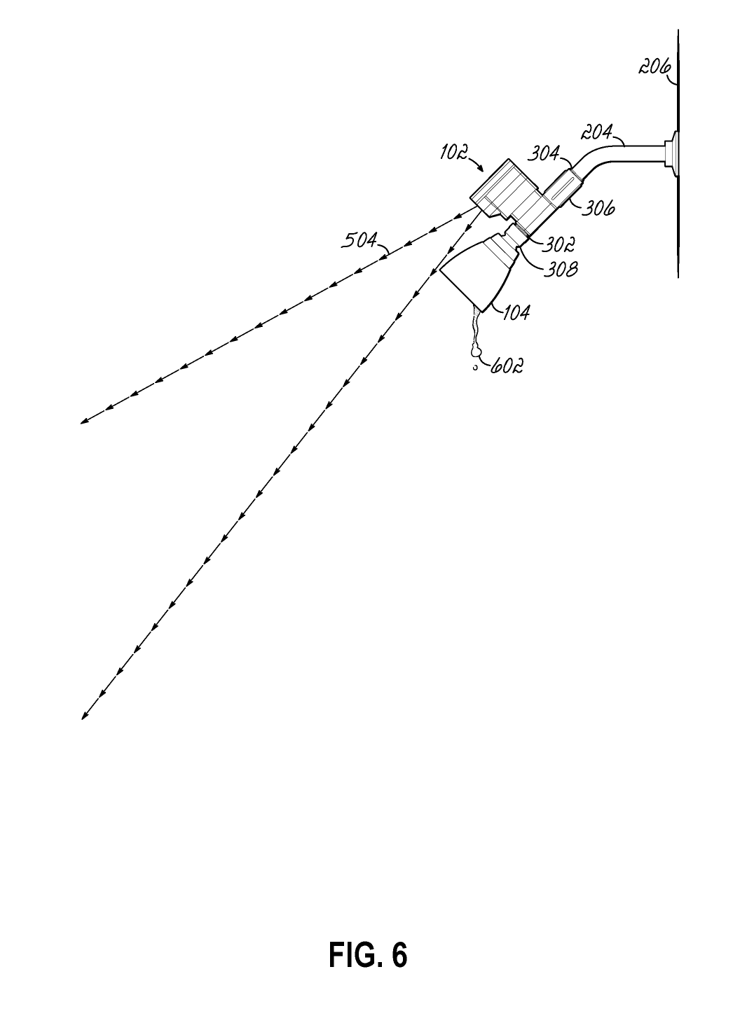

FIG. 6 is a schematic illustration 600 of the installed showerhead controller in a configuration in which water is prevented from flowing, according to an embodiment. In this example, the person has moved out of range of the modular controller 102. In this configuration, the range sensor 108 detects the absence of the person. As such, infrared radiation 504 or ultrasonic waves 504 are not reflected back to the range sensor 108. In this state, the controller 102 stops the flow of water 602, as described in further detail below.

According to an embodiment, the solenoid may be a DC solenoid valve. The showerhead may further include a turbine or other generator for recharging the battery. As described above, range sensor 108 may be, for example, an infrared (IRE) or a sonic sensor, or any other sensor suitable for detecting the presence or absence of a person. The range sensor 108 is configured to communicate with the microprocessor, which is, in turn, configured to communicate with the solenoid valve.

According to an embodiment, the system may further include a non-transitory computer readable storage device having computer program instructions stored thereon. The computer program instruction may be configured to control the showerhead by opening and closing the solenoid valve. Rather than being a simple input/output mechanism based on a distance set-point, this software may quickly learn the appropriate distance indicating when the water should flow and when it should not.

According to an embodiment, the showerhead may be programmed to not take any action for a preprogrammed amount of time during a buffer period from the point of first sensing a person in the field of its sensor. For example, the showerhead may be programmed to not take any action for approximately the first ten seconds. In this manner, the showerhead may account for the person entering the shower and may perform steady state sensing in order to determine the person's height and typical distance from the showerhead for rinsing. The microprocessor may then send an “open” signal to the solenoid valve to activate the flow of the water.

According to an embodiment, when the person steps away from the showerhead (e.g. outside of the determined typical distance), such as, for example, to lather, the showerhead may sense that event for a preprogrammed amount of time during a verification period. For example, the showerhead may sense the event for approximately one or two seconds without taking any action, in order to ensure that the person has indeed stepped away from the showerhead and that it is not a transient event. The microprocessor may then send a “close” signal to the solenoid valve to stop the flow of the water.

According to an embodiment, when the person steps toward the showerhead again (e.g. within the determined typical distance), the microprocessor may send an “open” signal to the solenoid valve to reactivate the flow of the water. It should be appreciated that, since the microprocessor is opening and closing the solenoid valve of the showerhead, rather than a valve at the mix control knob(s) of the shower, the water temperature may remain constant.

In one embodiment, the showerhead may reduce the amount of water used in a typical shower by approximately 50%. The showerhead may also decrease the amount of energy required to heat the water. As described herein, the showerhead is self-contained and may be used as a plug-and-play replacement for almost any other showerhead, thereby simplifying the installation process.

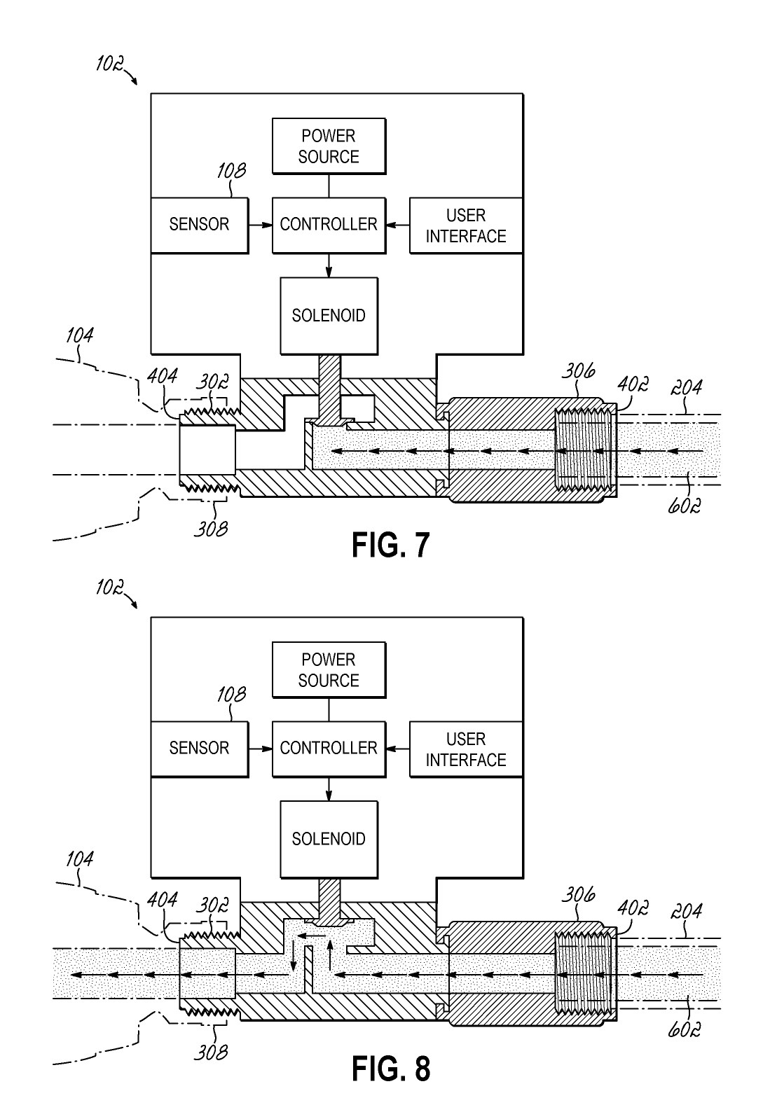

FIG. 7 is a schematic illustration of a cross sectional view of the installed showerhead controller in a configuration in which water is prevented from flowing, according to an embodiment, and FIG. 8 is a schematic illustration of a cross sectional view of the installed showerhead controller in a configuration in which water is allowed to flow, according to an embodiment. As shown in FIG. 7, a solenoid may cause a valve to close so as to block water flow. Similarly, as shown in FIG. 8, the solenoid may cause a valve to open so as to allow water to flow.

According to an embodiment, the solenoid may be a latching water electro-solenoid operating at a voltage that is greater than or equal to 5V. Such solenoids require an activation signal lasting no more than a duration of 50 ms. Further, such solenoids include magnets hold the solenoid in open or closed position. In contrast, if a convention electro-solenoid were to be used, then battery energy would be required to hold the solenoid open or closed and would quickly drain the battery pack.

According to an embodiment, the microprocessor may include a mini computer board with digital and analog I/O. For example, in some embodiments a Arduino Pro Mini may be used. In some embodiments, the battery pack may include 4 AAA cells. Such cells are expected to last at least two years under normal shower volume. Further embodiments may include a rechargeable lithium pack that is removable from the unit so that it may be charged outside of the shower environment.

According to an embodiment, the modular controller may include 3D printed or injection molded housing.

According to an embodiment, an infrared sensor may be used as the range sensor 108. However, this type of optical sensor may be susceptible to false positives because it can mistake steam for the user. If the steam is heavy enough (which tends to happen in shower environments, the IR beam may be reflected back to the sensor by the steam and may cause the system to be interpreted as the presence of a person in the shower stream when in fact they may not be. In further embodiments, an ultrasonic sensor may be used, as described above.

According to an embodiment, the system may include a small built-in generator that utilizes the water stream going through the system to generate electricity to charge the battery pack. Further embodiments may include rechargeable cells that are trickle charged by the generator such that the user should not have to replace the battery pack for a period of 8-10 years.

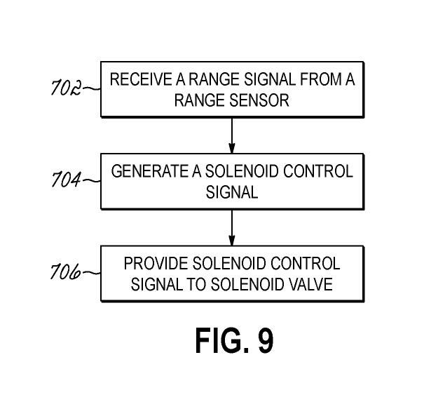

FIG. 9 is flow chart illustrating a processor based method of controlling a showerhead. In a first stage 702, the method includes receiving, by the processor, a range signal from a range sensor. In a second stage 704, the method includes generating, by the processor, a solenoid control signal based on the received range signal, and in a third stage 706, the method includes providing the solenoid control signal to the solenoid to control the solenoid to open or close, thereby letting water flow or not flow, respectively, depending on the range signal.

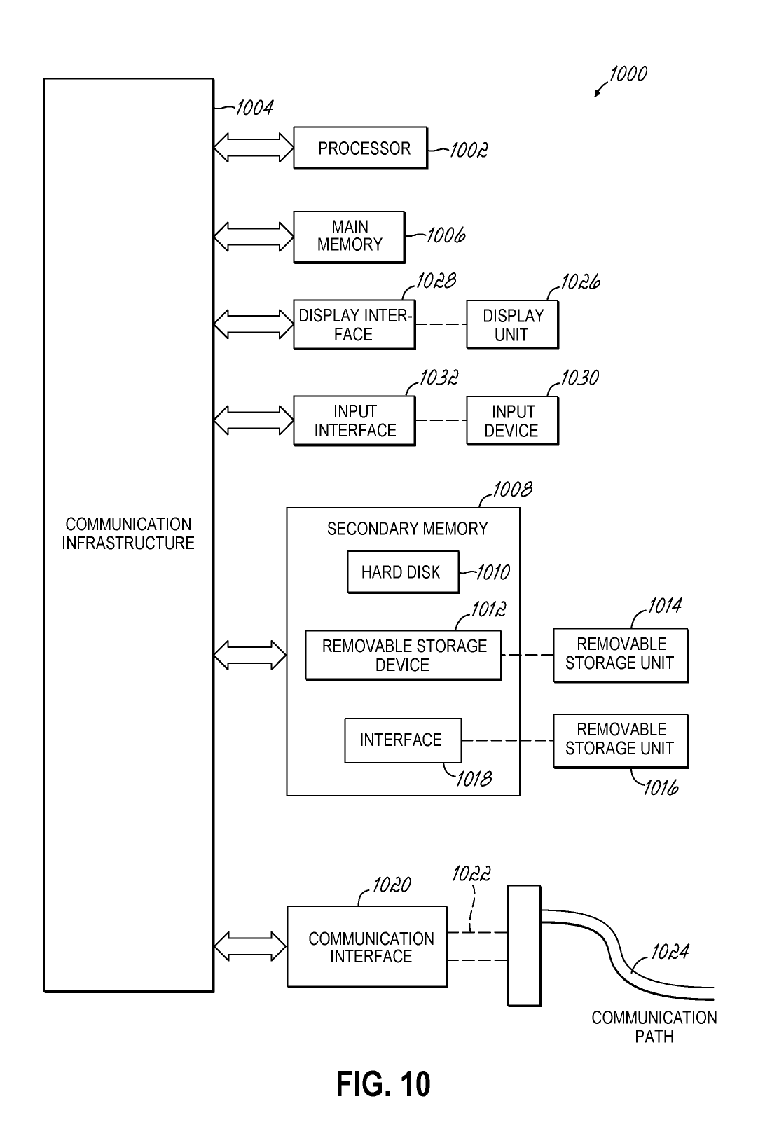

FIG. 10 is a block diagram of an example computer system 1000 in which embodiments of the disclosed invention, or portions thereof, may be implemented as computer-readable code, which is executed by one or more processors causing the one or more processors to perform operations of the disclosed invention, according to an embodiment.

According to an embodiment, system 102 (see FIG. 1) may be implemented on computer system 1000 using hardware, software, firmware, tangible computer readable media having instructions stored thereon, or a combination thereof and may be implemented in one or more computer systems or other processing system. If programmable logic is used, such logic may be executed on a commercially available processing platform or a special purpose device.

One of ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device.

Various embodiments of the invention are described in terms of this example computer system 1000. After reading this description, it will become apparent to persons of ordinary skill in the relevant art how to implement the invention using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

As will be appreciated by persons of ordinary skill in the relevant art, a computing device for implementing the disclosed invention has at least one processor, such as processor 2902, wherein the processor may be a single processor, a plurality of processors, a processor in a multi-core/multiprocessor system, such system operating alone, or in a cluster of computing devices operating in a cluster or server farm. Processor 1002 may be connected to a communication infrastructure 1004, for example, a bus, message queue, network, or multi-core message-passing scheme.

Computer system 1000 may also include a main memory 1006, for example, random access memory (RAM), and may also include a secondary memory 1008. Secondary memory 1008 may include, for example, a hard disk drive 1010, removable storage drive 1012. Removable storage drive 1012 may include a floppy disk drive, a magnetic tape drive, an optical disk drive, a flash memory, or the like. The removable storage drive 1012 may be configured to read and/or write data to a removable storage unit 1014 in a well-known manner. Removable storage unit 1014 may include a floppy disk, magnetic tape, optical disk, etc., which is read by and written to, by removable storage drive 1012. As will be appreciated by persons of ordinary skill in the relevant art, removable storage unit 1014 may include a computer readable storage medium having computer software (i.e., computer program instructions) and/or data stored thereon.

In alternative implementations, secondary memory 1008 may include other similar devices for allowing computer programs or other instructions to be loaded into computer system 1000. Such devices may include, for example, a removable storage unit 1016 and an interface 1018. Examples of such devices may include a program cartridge and cartridge interface (such as that found in video game devices), a removable memory chip (such as EPROM or PROM) and associated socket, and other removable storage units 1016 and interfaces 1018 which allow software and data to be transferred from the removable storage unit 1016 to computer system 1000.

Computer system 1000 may also include a communications interface 1020. Communications interface 1020 allows software and data to be transferred between computer system 1000 and external devices. Communications interfaces 1020 may include a modem, a network interface (such as an Ethernet card), a communications port, a PCMCIA slot and card, or the like. Software and data transferred via communications interface 1020 may be in the form of signals 1022, which may be electronic, electromagnetic, optical, or other signals capable of being received by communications interface 1020. These signals may be provided to communications interface 1020 via a communications path 1024.

In this document, the terms “computer program storage medium” and “computer usable storage medium” are used to generally refer to storage media such as removable storage unit 1014, removable storage unit 1016, and a hard disk installed in hard disk drive 1010. Computer program storage medium and computer usable storage medium may also refer to memories, such as main memory 1006 and secondary memory 1008, which may be semiconductor memories (e.g., DRAMS, etc.). Computer system 1000 may further include a display unit 1026 that interacts with communication infrastructure 1004 via a display interface 1028. Computer system 1000 may further include a user input device 1030 that interacts with communication infrastructure 1004 via an input interface 1032. A user input device 1030 may include a mouse, trackball, touch screen, or the like.

Computer programs (also called computer control logic or computer program instructions) are stored in main memory 1006 and/or secondary memory 1008. Computer programs may also be received via communications interface 1020. Such computer programs, when executed, enable computer system 1000 to implement embodiments as discussed herein. In particular, the computer programs, when executed, enable processor 1002 to implement the processes of embodiments of the invention, such as the stages in the method illustrated by flowchart of FIG. 9, discussed above. Accordingly, such computer programs represent controllers of the computer system 1000. When an embodiment is implemented using software, the software may be stored in a computer program product and loaded into computer system 1000 using removable storage drive 1012, interface 1018, and hard disk drive 1010, or communications interface 1020.

After reading this description, it will become apparent to persons of ordinary skill in the relevant art how to implement the invention using other computer systems and/or computer architectures. In addition, in some embodiments the order of operations may be rearranged without departing from the spirit of the disclosed subject matter. As will be appreciated by persons of ordinary skill in the relevant art, a computing device for implementing the disclosed invention has at least one processor. The system may also include a main memory for example, random access memory (RAM), and may also include a secondary memory.

In alternative implementations, secondary memory may include other similar devices for allowing computer programs or other instructions to be loaded into a computer system. Computer programs (also called computer control logic or computer program instructions) are stored in main memory and/or secondary memory.

Embodiments may be implemented using software, hardware, and/or operating system implementations other than those described herein. Any software, hardware, and operating system implementations suitable for performing the functions described herein can be utilized. Embodiments are applicable to both a client and to a server or a combination of both.

### CONCLUSION

The Summary and Abstract sections may set forth one or more but not all example embodiments and thus are not intended to limit the scope of embodiments of the invention and the appended claims in any way.

Embodiments have been described above with the aid of functional building blocks illustrating the implementation of specified functions and relationships thereof. The boundaries of these functional building blocks have been arbitrarily defined herein for the convenience of the description. Alternate boundaries can be defined to the extent that the specified functions and relationships thereof are appropriately performed.

The foregoing description of specific embodiments will so fully reveal the general nature of embodiments of the invention that others can, by applying knowledge of those of ordinary skill in the art, readily modify and/or adapt for various applications such specific embodiments, without undue experimentation, without departing from the general concept of embodiments of the invention. Therefore, such adaptation and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the specification is to be interpreted by persons of ordinary skill in the relevant art in light of the teachings and guidance presented herein.

The breadth and scope of embodiments of the invention should not be limited by any of the above-described example embodiments, but should be defined only in accordance with the following claims and their equivalents.

What is claimed is:

1. A showerhead for regulating water flow, the showerhead comprising:
a range sensor configured to detect the presence or absence of a person;
a solenoid valve configured to activate and stop water flow; and
a microprocessor configured to determine a person's typical distance from the showerhead when rinsing and configured to send an open signal to the solenoid valve when the person is within the typical distance and configured to send a close signal to the solenoid valve when the person is outside of the typical distance.

2. The showerhead of claim 1, wherein the solenoid valve comprises an electromagnetic DC solenoid valve.

3. The showerhead of claim 1, wherein the solenoid valve comprises a latching water electro-solenoid that is configured to be activated by an applied voltage greater than or equal to 5V.

4. The showerhead of claim 3, wherein the solenoid valve comprises magnets that hold the solenoid in an open or closed position.

5. The showerhead of claim 3, wherein energy is not drained from the battery when the solenoid is in an open or closed configuration.

6. The showerhead of claim 3, wherein the solenoid valve is configured to be activated by an activation signal having a time duration of 50 ms or less.

7. The showerhead of claim 1, wherein the microprocessor comprises a digital and analog input/output functionality.

8. The showerhead of claim 1, further comprising a battery.

9. The showerhead of claim 8, wherein the battery is configured to have a lifetime of at least two years under normal shower activity.

10. The showerhead of claim 8, wherein the battery is a rechargeable battery that is removable and is configured to be recharged using a charging unit outside of the shower environment.

11. The showerhead of claim 10, further comprising a turbine generator configured to recharge the battery.

12. The showerhead of claim 11, wherein the battery is configured to be trickle charged by the turbine generator.

13. The showerhead of claim 12, wherein the battery is configured to have a lifetime of a period from 8-10 years.

14. The showerhead of claim 1, further comprising an injection molded housing.

15. The showerhead of claim 1, further comprising a 3D printed housing.

16. The showerhead of claim 1, wherein the range sensor comprises an infrared sensor.

17. The showerhead of claim 1, wherein the range sensor comprises an ultrasonic distance sensor that is waterproof

18. The showerhead of claim 1, wherein the range sensor comprises an ultrasonic distance sensor that is configured to operate in a steam environment.

19. The showerhead of claim 1, further comprising a non-volatile computer readable storage device having computer program instructions stored thereon that, when executed by the microprocessor control the solenoid to open or close in response to measurements recorded by the range sensor.

20. A processor based method of controlling a showerhead, the method comprising:
receiving, by the processor, a range signal from a range sensor;
generating, by the processor, a solenoid control signal based on the received range signal;
providing the solenoid control signal to the solenoid to control the solenoid to open or close, thereby letting water flow or not flow, respectively, depending on the range signal.
